(19) United States
(12) Patent Application Publication
(10) Pub. No.: US 2026/0351271 A1
(43) Pub. Date: Nov. 5, 2026

(54) NOISE PROCESSING CIRCUIT, SIGNAL PROCESSING DEVICE, NOISE PROCESSING METHOD, AND NON-TRANSITORY RECORDING MEDIUM

(71) Applicant: TDK CORPORATION, Tokyo (JP)

(72) Inventors: Shogo TOKI, Tokyo (JP); Satoshi KINOSHITA, Tokyo (JP); Toshihiro FUJII, Tokyo (JP)

(73) Assignee: TDK CORPORATION, Tokyo (JP)

(21) Appl. No.: 19/116,399

(22) PCT Filed: Sep. 30, 2022
(86) PCT No.: PCT/JP2022/036788

§ 371 Date: Mar. 28, 2025

(51) Int. Cl. G10L 21/0232; G10L 21/0216; G10L 25/51

(52) U.S. Cl. CPC G10L 21/0232; G10L 25/51; G10L 2021/02166

(57) ABSTRACT

A noise processing circuit includes: a detector detecting a sound source, based on multiple signals; a flag signal generator generating a flag signal indicating a period during which the multiple signals each include a first signal component; a beamforming processor generating a first signal by emphasizing the first signal component and a second signal by de-emphasizing the first signal component, based on the multiple signals and the flag signal; a noise model generator generating, based on the flag signal, noise models each corresponding to a spectrum of the first signal; a noise model selector selecting one of the noise models by selecting the first or second signal, based on the flag signal and by calculating similarity in spectrum between the selected signal and each of the noise models; and a spectral subtractor performing spectral subtraction processing, based on the spectrum of the first signal and the selected noise model.

### TECHNICAL FIELD

The disclosure relates to a noise processing circuit, a signal processing device, and a noise processing method that each perform noise processing based on multiple signals obtained by multiple microphones, and a non-transitory recording medium that holds software configured to perform noise processing based on multiple signals obtained by multiple microphones.

### BACKGROUND ART

Some of signal processing devices perform processing based on multiple signals obtained by multiple microphones. In such signal processing devices, for example, noise processing is performed based on the multiple signals, and predetermined processing is performed based on the signals having undergone the noise processing. For example, Patent Literature 1 discloses a technique of reducing a wind noise component that is non-stationary noise, without loss of quality of an audio signal.

### CITATION LIST

### Patent Literature

Patent Literature 1: Japanese Unexamined Patent Application Publication No. 2014-126856

### SUMMARY

A noise processing circuit according to one embodiment of the disclosure includes a detector, a flag signal generator, a beamforming processor, a noise model generator, a noise model selector, and a spectral subtractor. The detector is configured to detect a sound source, based on multiple signals supplied from multiple microphones. The flag signal generator is configured to generate, based on a result of detecting by the detector, a flag signal that indicates a period during which the multiple signals each include a first signal component. The beamforming processor is configured to generate, based on the multiple signals and the flag signal, a first signal by emphasizing the first signal component in the period during which the multiple signals each include the first signal component, and a second signal by de-emphasizing the first signal component in the period during which the multiple signals each include the first signal component. The noise model generator is configured to generate, based on the flag signal, multiple noise models in a period during which the multiple signals each do not include the first signal component, the multiple noise models each corresponding to a spectrum of the first signal. The noise model selector is configured to select one noise model from among the multiple noise models by selecting, based on the flag signal, one of the first signal or the second signal and by calculating similarity in spectrum between the one of the first signal or the second signal selected and each of the multiple noise models. The spectral subtractor is configured to perform spectral subtraction processing, based on the spectrum of the first signal and the one noise model selected by the noise model selector.

A signal processing device according to one embodiment of the disclosure includes a noise processing circuit and a processing circuit. The noise processing circuit is configured to perform noise processing, based on multiple signals supplied from multiple microphones. The processing circuit is configured to perform signal processing, based on a result of processing by the noise processing circuit. The noise processing circuit includes a detector, a flag signal generator, a beamforming processor, a noise model generator, a noise model selector, and a spectral subtractor. The detector is configured to detect a sound source, based on the multiple signals supplied from the multiple microphones. The flag signal generator is configured to generate, based on a result of detecting by the detector, a flag signal that indicates a period during which the multiple signals each include a first signal component. The beamforming processor is configured to generate, based on the multiple signals and the flag signal, a first signal by emphasizing the first signal component in the period during which the multiple signals each include the first signal component, and a second signal by de-emphasizing the first signal component in the period during which the multiple signals each include the first signal component. The noise model generator is configured to generate, based on the flag signal, multiple noise models in a period during which the multiple signals each do not include the first signal component, the multiple noise models each corresponding to a spectrum of the first signal. The noise model selector is configured to select one noise model from among the multiple noise models by selecting, based on the flag signal, one of the first signal or the second signal and by calculating similarity in spectrum between the one of the first signal or the second signal selected and each of the multiple noise models. The spectral subtractor is configured to perform spectral subtraction processing, based on the spectrum of the first signal and the one noise model selected by the noise model selector.

A noise processing method according to one embodiment of the disclosure includes: detecting a sound source, based on multiple signals supplied from multiple microphones; generating, based on a result of the detecting of the sound source, a flag signal that indicates a period during which the multiple signals each include a first signal component; generating, based on the multiple signals and the flag signal, a first signal by emphasizing the first signal component in the period during which the multiple signals each include the first signal component; generating, based on the multiple signals and the flag signal, a second signal by de-emphasizing the first signal component in the period during which the multiple signals each include the first signal component; generating, based on the flag signal, multiple noise models in a period during which the multiple signals each do not include the first signal component, the multiple noise models each corresponding to a spectrum of the first signal; selecting one noise model from among the multiple noise models by selecting, based on the flag signal, one of the first signal or the second signal and by calculating similarity in spectrum between the one of the first signal or the second signal selected and each of the multiple noise models; and performing spectral subtraction processing, based on the spectrum of the first signal and the one noise model selected from among the multiple noise models.

A non-transitory computer-readable recording medium according to one embodiment of the disclosure includes software. The software is configured to cause a processor to: detect a sound source, based on multiple signals supplied from multiple microphones; generate, based on a result of detecting of the sound source, a flag signal that indicates a period during which the multiple signals each include a first signal component; generate, based on the multiple signals and the flag signal, a first signal by emphasizing the first signal component in the period during which the multiple signals each include the first signal component; generate, based on the multiple signals and the flag signal, a second signal by de-emphasizing the first signal component in the period during which the multiple signals each include the first signal component; generate, based on the flag signal, multiple noise models in a period during which the multiple signals each do not include the first signal component, the multiple noise models each corresponding to a spectrum of the first signal; select one noise model from among the multiple noise models by selecting, based on the flag signal, one of the first signal or the second signal and by calculating similarity in spectrum between the one of the first signal or the second signal selected and each of the multiple noise models; and perform spectral subtraction processing, based on the spectrum of the first signal and the one noise model selected from among the multiple noise models.

### BRIEF DESCRIPTION OF DRAWINGS

FIG. 1 is a block diagram illustrating a configuration example of a signal processing device according to one example embodiment of the disclosure.

FIG. 2 is an explanatory diagram illustrating an operation example of a noise processing circuit illustrated in FIG. 1.

FIG. 3 is a waveform chart illustrating an operation example of a sound source detector and a sound source selector illustrated in FIG. 1.

FIG. 4 is a block diagram illustrating a configuration example of a beamforming processor illustrated in FIG. 1.

FIG. 5 is an explanatory diagram illustrating an operation example of a Fourier transformer illustrated in FIG. 1.

FIG. 6 is an explanatory diagram illustrating an operation example of a noise model generator illustrated in FIG. 1.

FIG. 7 is an explanatory diagram illustrating an operation example of a noise model selector illustrated in FIG. 1.

FIG. 8 is a block diagram illustrating a configuration example of a beamforming processor according to a modification example.

FIG. 9 is a block diagram illustrating a configuration example of a beamforming processor according to another modification example.

FIG. 10 is a block diagram illustrating a configuration example of a beamforming processor according to another modification example.

FIG. 11 is a block diagram illustrating a configuration example of a beamforming processor according to another modification example.

### DETAILED DESCRIPTION

Regarding noise processing on multiple signals obtained by multiple microphones, it is desired to reduce non-stationary noise without loss of quality of a desired signal component, and expectations are placed on effective reduction of the non-stationary noise.

It is desirable to provide a noise processing circuit, a signal processing device, a noise processing method, and a non-transitory recording medium that each make it possible to effectively reduce non-stationary noise.

In the following, a description will be given in detail of some example embodiments of the disclosure with reference to the drawings.

### Example Embodiment

### Configuration Example

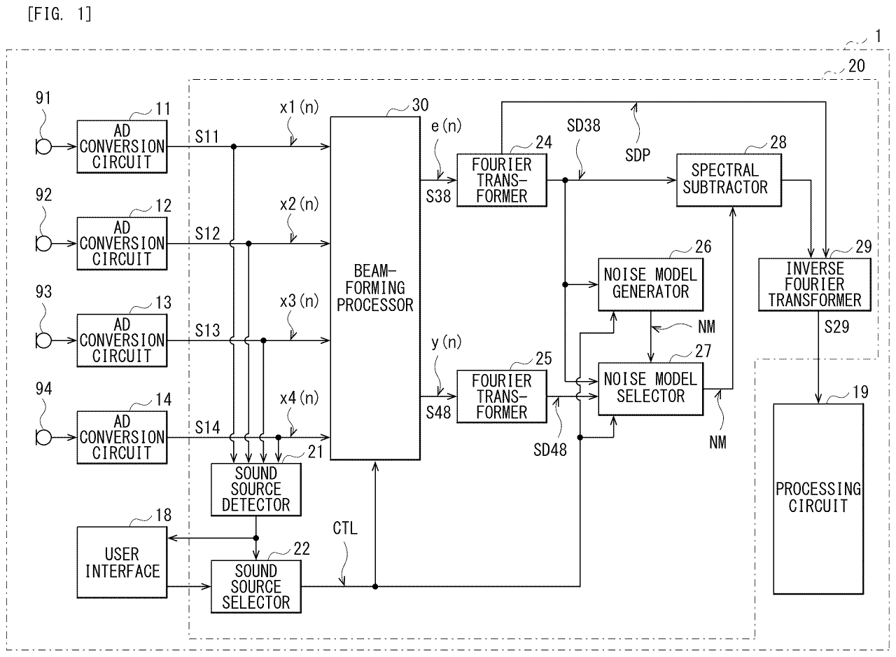

FIG. 1 illustrates a configuration example of a signal processing device 1 including a noise processing circuit according to an example embodiment of the disclosure. In this example, the signal processing device 1 is configured to generate a signal with reduced noise by performing noise processing, based on four signals supplied from four microphones, and to perform predetermined signal processing, based on the signal. The signal processing device 1 includes microphones 91 to 94, analog-to-digital (AD) conversion circuits 11 to 14, a user interface 18, a noise processing circuit 20, and a processing circuit 19.

The microphones 91 to 94 are each configured to convert a sound wave into an electric signal. The microphones 91 to 94 are disposed at a distance from each other, for example. This makes it possible for the microphones 91 to 94 to detect sound waves from directions different from each other.

The AD conversion circuit 11 is configured to generate a signal S11 by performing AD conversion, based on the electric signal supplied from the microphone 91. The AD conversion circuit 11 performs the AD conversion at a sampling frequency fs to thereby sequentially generate pieces of data x1, and outputs the pieces of data x1 as the signal S11. Data×1(n) in FIG. 1 represents an n-th piece of data x1. The sampling frequency fs is 16 kHz, for example.

Similarly, the AD conversion circuit 12 is configured to generate a signal S12 by performing AD conversion, based on the electric signal supplied from the microphone 92. The AD conversion circuit 12 performs the AD conversion at the sampling frequency fs to thereby sequentially generate pieces of data x2, and outputs the pieces of data x2 as the signal S12. Data x2(n) in FIG. 1 represents an n-th piece of data x2. The AD conversion circuit 13 is configured to generate a signal S13 by performing AD conversion, based on the electric signal supplied from the microphone 93. The AD conversion circuit 13 performs the AD conversion at the sampling frequency fs to thereby sequentially generate pieces of data x3, and outputs the pieces of data x3 as the signal S13. Data x3(n) in FIG. 1 represents an n-th piece of data x3. The AD conversion circuit 14 is configured to generate a signal S14 by performing AD conversion, based on the electric signal supplied from the microphone 94. The AD conversion circuit 14 performs the AD conversion at the sampling frequency fs to thereby sequentially generate pieces of data x4, and outputs the pieces of data x4 as the signal S14. Data x4(n) in FIG. 1 represents an n-th piece of data x4. The AD conversion circuits 11 to 14 perform the AD conversion in synchronization with each other.

The user interface 18 is configured to present information to a user of the signal processing device 1 and receive a user operation. The user interface 18 includes, for example, a display panel, an indicator, an operation button, etc. The user is thus allowed to perform various settings of the signal processing device 1 by operating the user interface 18.

The noise processing circuit 20 is configured to generate a signal S29 with reduced noise, by performing noise processing based on the signals S11 to S14 supplied from the AD conversion circuits 11 to 14. The noise processing circuit 20 performs the noise processing by using a spectral subtraction method. The noise processing circuit 20 includes, for example, a processor, a memory, etc., and operates by executing software.

FIG. 2 schematically illustrates an operation example of the noise processing circuit 20. Part (A) of FIG. 2 illustrates a signal before undergoing the noise processing, and part (B) of FIG. 2 illustrates the signal having undergone the noise processing. A waveform W1 illustrated in a thin line indicates a noise component, and a waveform W2 illustrated in a thick line indicates a desired signal component, such as a sound. Before the noise processing is performed, as illustrated in part (A) of FIG. 2, the noise component (the waveform W1) is large and the desired signal component (the waveform W2) is buried in the noise component. In this example, in particular, the noise component includes not only stationary noise but also non-stationary noise. In FIG. 2, the non-stationary noise occurs in a period T1 and a period T2. After the noise processing is performed, as illustrated in part (B) of FIG. 2, the noise component (the waveform W1) is reduced, with the desired signal component (the waveform W2) substantially retained. In this way, the noise processing circuit 20 makes it possible to reduce the noise component including stationary noise and non-stationary noise, while substantially retaining the desired signal component.

The noise processing circuit 20 illustrated in FIG. 1 includes a sound source detector 21, a sound source selector 22, a beamforming processor 30, Fourier transformers 24 and 25, a noise model generator 26, a noise model selector 27, a spectral subtractor 28, and an inverse Fourier transformer 29.

The sound source detector 21 is configured to detect the kind of a sound source, based on the signals S11 to S14 supplied from the AD conversion circuits 11 to 14.

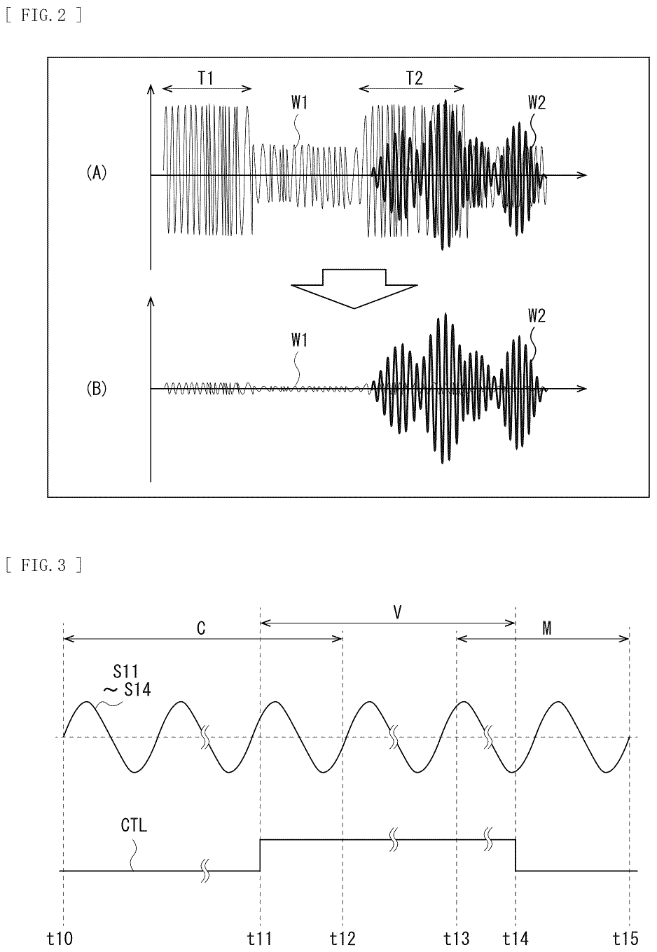

FIG. 3 illustrates an operation example of the sound source detector 21 and the sound source selector 22. The sound source detector 21 detects what sound source a signal component included in each of the signals S11 to S14 relates to, and generates metadata indicating the kind of the sound source. In this example, “V” represents a human voice, “M” represents a musical sound, and “C” represents a vehicle traveling sound. For example, the signals S11 to S14 each include a signal component of the vehicle traveling sound during a period from a timing t10 to a timing t12, a signal component of the human voice during a period from a timing t11 to a timing t14, and a signal component of the musical sound during a period from a timing t13 to a timing t15.

The sound source detector 21 performs sound source detection, based on a predetermined number of (e.g., 512) pieces of data x1 included in the signal S11, a predetermined number of (e.g., 512) pieces of data x2 included in the signal S12, a predetermined number of (e.g., 512) pieces of data x3 included in the signal S13, and a predetermined number of (e.g., 512) pieces of data x4 included in the signal S14, for example. In performing the sound source detection, the sound source detector 21 uses, as a basis, a signal component of a sound source whose S/N ratio is greater than or equal to a predetermined value, among signal components of various sound sources included in each of the signals S11 to S14, and detects the sound source indicated by such a signal component. Specifically, referring to the example of FIG. 3, in the period from the timing t10 to the timing t12, the sound source detector 21 generates metadata indicating the vehicle traveling sound when the S/N ratio of the signal component of the vehicle traveling sound is greater than or equal to the predetermined value; in the period from the timing t11 to the timing t14, the sound source detector 21 generates metadata indicating the human voice when the S/N ratio of the signal component of the human voice is greater than or equal to the predetermined value; and in the period from the timing t13 to the timing t15, the sound source detector 21 generates metadata indicating the musical sound when the S/N ratio of the signal component of the musical sound is greater than or equal to the predetermined value. Thereafter, the sound source detector 21 supplies the metadata to the user interface 18 and the sound source selector 22.

Based on the metadata supplied from the sound source detector 21, the user interface 18 illustrated in FIG. 1 presents information on the kind of the sound source to the user. The user recognizes that the signal processing device 1 has detected, for example, the human voice, the musical sound, the vehicle traveling sound, etc. Thereafter, the user performs a selection operation to select a sound source, from among the foregoing sound sources, to allow the noise processing circuit 20 to operate based on the signal component of the selected sound source. The noise processing circuit 20 performs processing, based on the selection operation performed by the user. For example, when the user has performed the selection operation to select the human voice, the noise processing circuit 20 performs the processing with the human voice as a target sound source. In such a case, for example, the musical sound is a noise component. For example, when the user has performed the selection operation to select the musical sound, the noise processing circuit 20 performs the processing with the musical sound as the target sound source. In such a case, for example, the human voice is a noise component. The user interface 18 receives such selection operations performed by the user. Thereafter, the user interface 18 supplies information on the user's selection operation to the sound source selector 22.

The sound source selector 22 is configured to generate a flag signal CTL, based on the metadata supplied from the sound source detector 21 and the information on the user's selection operation supplied from the user interface 18. The flag signal CTL is a signal that is to be made active in a period during which the signals S11 to S14 each include the signal component of the user's selected sound source, and made inactive in other periods.

In the example of FIG. 3, when the user has performed the selection operation to select the human voice, for example, the sound source selector 22 makes the flag signal CTL active (in this example, sets the flag signal CTL to a high level) in the period from the timing t11 to the timing t14 during which the signals S11 to S14 each include the signal component of the human voice, and makes the flag signal CTL inactive (in this example, sets the flag signal CTL to a low level) in other periods. The sound source selector 22 generates the flag signal CTL in such a manner, and supplies the flag signal CTL thus generated to the beamforming processor 30, the noise model generator 26, and the noise model selector 27.

The beamforming processor 30 is configured to generate a sound source signal S38 and a pseudo-noise signal S48, based on the signals S11 to S14 and the flag signal CTL. The sound source signal S38 is a signal in which the signal component of the user's selected sound source is emphasized. The pseudo-noise signal S48 is a signal that includes signal components corresponding to the noise components included in the signals S11 to S14, with the signal component of the user's selected sound source de-emphasized.

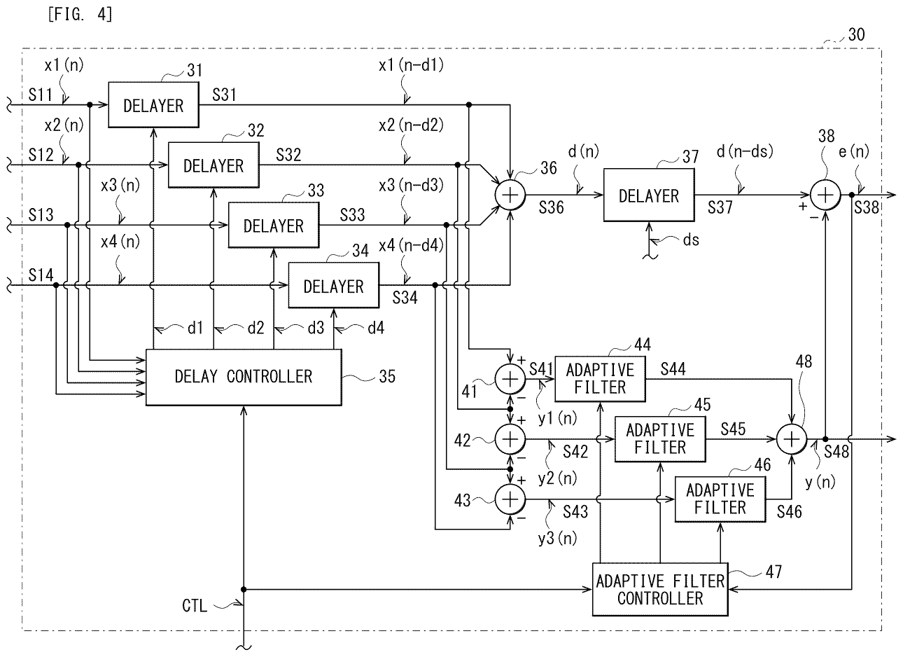

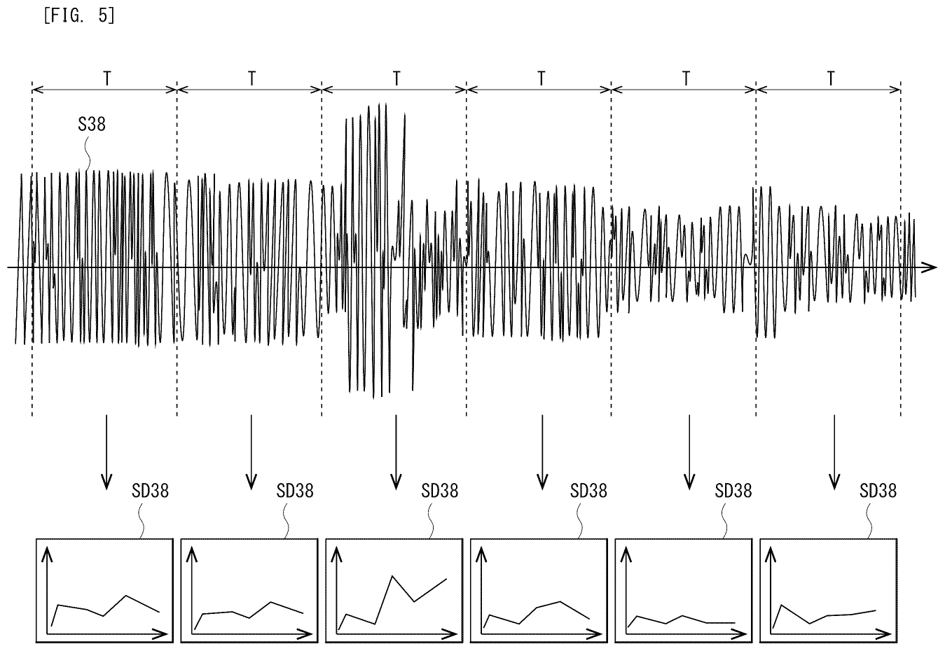

FIG. 4 illustrates a configuration example of the beamforming processor 30. The beamforming processor 30 includes delayers 31 to 34, a delay controller 35, an adder 36, a delayer 37, subtractors 41 to 43, adaptive filters 44 to 46, an adaptive filter controller 47, an adder 48, and a subtractor 38.

The delayer 31 is configured to generate a signal S31 by delaying the signal S11 by a delay amount d1. Specifically, the delayer 31 delays the signal S11 by the delay amount d1 by shifting a phase of the signal S11 in units of a sampling period Ts (=1/fs). Data x1(n-d1) in FIG. 4 is data resulting from delaying the data x1(n) by the delay amount d1. The delay amount dl of the delayer 31 is set by the delay controller 35.

Similarly, the delayer 32 is configured to generate a signal S32 by delaying the signal S12 by a delay amount d2. Specifically, the delayer 32 delays the signal S12 by the delay amount d2 by shifting a phase of the signal S12 in units of the sampling period Ts (=1/fs). Data x2(n-d2) in FIG. 4 is data resulting from delaying the data x2(n) by the delay amount d2. The delay amount d2 of the delayer 32 is set by the delay controller 35. The delayer 33 is configured to generate a signal S33 by delaying the signal S13 by a delay amount d3. Specifically, the delayer 33 delays the signal S13 by the delay amount d3 by shifting a phase of the signal S13 in units of the sampling period Ts (=1/fs). Data x3(n-d3) in FIG. 4 is data resulting from delaying the data x3(n) by the delay amount d3. The delay amount d3 of the delayer 33 is set by the delay controller 35. The delayer 34 is configured to generate a signal S34 by delaying the signal S14 by a delay amount d4. Specifically, the delayer 34 delays the signal S14 by the delay amount d4 by shifting a phase of the signal S14 in units of the sampling period Ts (=1/fs). Data x4(n-d4) in FIG. 4 is data resulting from delaying the data x4(n) by the delay amount d4. The delay amount d4 of the delayer 34 is set by the delay controller 35.

The delay controller 35 is configured to generate, based on the flag signal CTL and the signals S11 to S14, the respective delay amounts d1 to d4 of the delayers 31 to 34 to allow the respective signal components of the user's selected sound source that are included in the signals S11 to S14 to be in phase with each other. Specifically, in the period during which the flag signal CTL is at the high level (active), the delay controller 35 so updates the delay amounts d1 to d4 as to allow the signal components of the user's selected sound source to be in phase with each other. The delayers 31 to 34 respectively generate the signals S31 to S34 by delaying the signals S11 to S14, based on the respective delay amounts d1 to d4 thus updated. The respective signal components of the user's selected sound source in the signals S31 to S34 are thereby controlled to be in phase with each other.

More specifically, the microphones 91 to 94 detect respective sound waves from directions different from each other. Accordingly, depending on the direction of the sound source as viewed from the signal processing device 1, the respective signal components of the user's selected sound source that are included in the signals S11 to S14 can be out of phase with each other. Further, there is a possibility that one of the microphones 91 to 94 directly detects a sound wave from the sound source whereas another one of the microphones 91 to 94 detects a sound wave reflected by an object. This can cause the respective signal components of the user's selected sound source that are included in the signals S11 to S14 to be out of phase with each other. Further, characteristic differences between the microphones 91 to 94 or characteristic differences between the AD conversion circuits 11 to 14 can also cause the respective signal components of the user's selected sound source that are included in the signals S11 to S14 to be out of phase with each other. The delay controller 35 generates the delay amounts d1 to d4, based on the flag signal CTL and the signals S11 to S14, to allow the respective signal components of the user's selected sound source (the target sound source) that are included in the signals S11 to S14 to be in phase with each other. The delay controller 35 thereby adjusts the differences between the directions of the sound source and adjusts the characteristic differences between the microphones 91 to 94.

Further, during the period during which the flag signal CTL is at the low level (inactive), the delay controller 35 refrains from updating the delay amounts d1 to d4 and retains the delay amounts d1 to d4. The delayers 31 to 34 thus uses the retained delay amounts d1 to d4 to delay the signals S11 to S14, respectively. More specifically, during the period during which the flag signal CTL is at the low level (inactive), the signals S11 to S14 include no signal components of the user's selected sound source; therefore, the delay controller 35 refrains from updating the delay amounts d1 to d4. Accordingly, the delayers 31 to 34 delay the signals S11 to S14, respectively based on the retained delay amounts d1 to d4.

The adder 36 is configured to generate a signal S36 by adding up the signals S31 to S34 respectively supplied from the delayers 31 to 34. Specifically, the adder 36 adds up the data x1(n-d1), the data x2(n-d2), the data x3(n-d3), and the data x4(n-d4) to thereby generate the data d(n). As described above, the respective signal components of the user's selected sound source that are included in the signals S31 to S34 are in phase with each other. The adder 36 adds up these signals S31 to S34 to thereby generate the signal S36 in which the signal component of the user's selected sound source (the target sound source) is emphasized.

The delayer 37 is configured to generate a signal S37 by delaying the signal S36 supplied from the adder 36 by a delay amount ds. Specifically, the delayer 37 delays the signal S36 by the delay amount ds by shifting a phase of the signal S36 in units of the sampling period Ts (=1/fs). Data d(n-ds) in FIG. 4 is data resulting from delaying the data d(n) by the delay amount ds. The delay amount ds of the delayer 37 is of a predetermined value set by an unillustrated controller.

The subtractor 41 is configured to generate a signal S41 by subtracting the signal S32 supplied from the delayer 32 from the signal S31 supplied from the delayer 31. Specifically, the subtractor 41 subtracts the data x2(n-d2) from the data x1(n-d1) to thereby generate data y1(n). As described above, the respective signal components of the user's selected sound source that are included in the signals S31 and S32 are in phase with each other. The subtractor 41 subtracts the signal S32 from the signal S31 to thereby generate the signal S41 in which the signal component of the user's selected sound source is de-emphasized.

Similarly, the subtractor 42 is configured to generate a signal S42 by subtracting the signal S33 supplied from the delayer 33 from the signal S32 supplied from the delayer 32. Specifically, the subtractor 42 subtracts the data x3(n-d3) from the data x2(n-d2) to thereby generate data y2(n). As described above, the respective signal components of the user's selected sound source that are included in the signals S32 and S33 are in phase with each other. The subtractor 42 subtracts the signal S33 from the signal S32 to thereby generate the signal S42 in which the signal component of the user's selected sound source is de-emphasized. The subtractor 43 is configured to generate a signal S43 by subtracting the signal S34 supplied from the delayer 34 from the signal S33 supplied from the delayer 33. Specifically, the subtractor 43 subtracts the data x4(n-d4) from the data x3(n-d3) to thereby generate data y3(n). As described above, the respective signal components of the user's selected sound source that are included in the signals S33 and S34 are in phase with each other. The subtractor 43 subtracts the signal S34 from the signal S33 to thereby generate the signal S43 in which the signal component of the user's selected sound source is de-emphasized.

The adaptive filter 44 is configured to generate a signal S44 by performing filter processing on the signal S41 supplied from the subtractor 41. The adaptive filter 44 is a finite impulse response (FIR) filter. The adaptive filter 44 adjusts an amplitude and a phase of the signal S41 by performing a convolution operation on the signal S41 through the use of a filter coefficient supplied from the adaptive filter controller 47.

Similarly, the adaptive filter 45 is configured to generate a signal S45 by performing filter processing on the signal S42 supplied from the subtractor 42. The adaptive filter 45 is an FIR filter. The adaptive filter 45 adjusts an amplitude and a phase of the signal S42 by performing a convolution operation on the signal S42 through the use of a filter coefficient supplied from the adaptive filter controller 47. The adaptive filter 46 is configured to generate a signal S46 by performing filter processing on the signal S43 supplied from the subtractor 43. The adaptive filter 46 is an FIR filter. The adaptive filter 46 adjusts an amplitude and a phase of the signal S43 by performing a convolution operation on the signal S43 through the use of a filter coefficient supplied from the adaptive filter controller 47.

The adaptive filter controller 47 is configured to generate each of the filter coefficient to be supplied to the adaptive filter 44, the filter coefficient to be supplied to the adaptive filter 45, and the filter coefficient to be supplied to the adaptive filter 46, based on the flag signal CTL and the sound source signal S38 supplied from the subtractor 38, to cause noise in the sound source signal S38 to be lower. Specifically, in the period during which the flag signal CTL is at the low level (inactive), the adaptive filter controller 47 so updates the respective filter coefficients to be supplied to the adaptive filters 44 to 46 as to cause noise in the sound source signal S38 to be lower. The adaptive filters 44 to 46 perform the filter processing through the use of the respective filter coefficients thus updated.

During the period during which the flag signal CTL is at the high level (active), the adaptive filter controller 47 refrains from updating the filter coefficients and retains the filter coefficients. The adaptive filters 44 to 46 perform the filter processing through the use of the respective filter coefficients thus retained.

The adder 48 is configured to generate the pseudo-noise signal S48 by adding up the signals S44 to S46 respectively supplied from the adaptive filters 44 to 46. Specifically, the adder 48 adds up respective pieces of data supplied from the adaptive filters 44 to 46 to thereby generate data y(n). The data y(n) represents an n-th piece of data y.

The subtractor 38 is configured to generate the sound source signal S38 by subtracting the pseudo-noise signal S48 supplied from the adder 48 from the signal S37 supplied from the delayer 37. Specifically, the subtractor 38 subtracts the data y(n) from the data d(n-ds) to thereby generate data e(n). The data e(n) represents an n-th piece of data e.

With this configuration, the adaptive filters 44 to 46, the adaptive filter controller 47, the adder 48, and the subtractor 38 perform a negative feedback operation to cause noise in the sound source signal S38 to be lower. In other words, the adaptive filters 44 to 46, the adaptive filter controller 47, the adder 48, and the subtractor 38 perform a negative feedback operation to cause the pseudo-noise signal S48 to be equal to a noise component included in the signal S37 supplied to the subtractor 38.

In this way, in the beamforming processor 30, the adder 36 adds up the signals S31 to S34 whose signal components of the user's selected sound source (the target sound source) are in phase with each other to thereby emphasize the signal component of the user's selected sound source in the sound source signal S38. Further, the subtractor 38 subtracts the pseudo-noise signal S48 from the signal S37 to thereby emphasize the signal component of the user's selected sound source in the sound source signal S38. The beamforming processor 30 thus generates the sound source signal S38 in which the signal component of the user's selected sound source is emphasized.

Note that when, for example, one or more of the signals S11 to S14 include no signal component of the target sound source, the beamforming processor 30 excludes the one or more signals including no signal component of the target sound source from targets of the processing at the beamforming processor 30. For example, when the signal S14 includes no signal component of the target sound source, the adder 36 adds up the signals S31 to S33 to thereby generate the signal S36. In other words, the adder 36 refrains from adding the signal S34. The adder 36 thus adds up, among the signals S31 to S34, ones each including the signal component of the target sound source. Similarly, the subtractors 41 to 43 each perform subtraction by appropriately combining, among the signals S31 to S34, ones each including the signal component of the target sound source.

The Fourier transformer 24 illustrated in FIG. 1 is configured to calculate amplitude spectral data SD38 and phase spectral data SDP of the sound source signal S38 by performing a discrete Fourier transform, based on the sound source signal S38 supplied from the beamforming processor 30.

FIG. 5 illustrates an operation example of the Fourier transformer 24. For example, each time a predetermined number of (e.g., 512) pieces of data e are supplied via the sound source signal S38, the Fourier transformer 24 performs a discrete Fourier transform based on these pieces of data to thereby generate the amplitude spectral data SD38 and the phase spectral data SDP of the sound source signal S38. Note that FIG. 5 omits illustration of the phase spectral data SDP. In the amplitude spectral data SD38, a horizontal axis represents frequency, and a vertical axis represents a magnitude of amplitude. In FIG. 5, the Fourier transformer 24 is supplied with the predetermined number of (e.g., 512) pieces of data e from the beamforming processor 30 in a processing period T. In each processing period T, the Fourier transformer 24 performs a discrete Fourier transform, based on these pieces of data e to thereby calculate the amplitude spectral data SD38 and the phase spectral data SDP of the sound source signal S38. Thereafter, the Fourier transformer 24 supplies the amplitude spectral data SD38 thus generated to the noise model generator 26, the noise model selector 27, and the spectral subtractor 28, and supplies the phase spectral data SDP thus generated to the inverse Fourier transformer 29.

The Fourier transformer 25 illustrated in FIG. 1 is configured to calculate amplitude spectral data SD48 of the pseudo-noise signal S48 by performing a discrete Fourier transform, based on the pseudo-noise signal S48 supplied from the beamforming processor 30. Specifically, for example, as with the Fourier transformer 24, each time a predetermined number of (e.g., 512) pieces of data y are supplied via the pseudo-noise signal S48, the Fourier transformer 25 performs a discrete Fourier transform, based on these pieces of data to thereby generate the amplitude spectral data SD48 of the pseudo-noise signal S48. Thereafter, the Fourier transformer 25 supplies the amplitude spectral data SD48 thus generated to the noise model selector 27.

The noise model generator 26 is configured to generate a noise model NM, based on the flag signal CTL and the amplitude spectral data SD38 of the sound source signal S38 that is supplied from the Fourier transformer 24. The noise model NM is amplitude spectral data indicating noise. In the period during which the flag signal CTL is at the low level (inactive), the noise model generator 26 generates the noise model NM, based on the amplitude spectral data SD38 of the sound source signal S38 supplied from the Fourier transformer 24. More specifically, during the period during which the flag signal CTL is at the low level (inactive), the signals S11 to S14 each include no signal component of the user's selected sound source (the target sound source); therefore, in this period, the noise model generator 26 generates the noise model NM, based on the amplitude spectral data SD38 of the sound source signal S38. Thereafter, the noise model generator 26 supplies the noise model NM thus generated to the noise model selector 27.

The noise model selector 27 is configured to accumulate multiple noise models NM supplied from the noise model generator 26 and to select one noise model NM from among the multiple noise models NM thus accumulated, based on the flag signal CTL, the amplitude spectral data SD38 of the sound source signal S38 supplied from the Fourier transformer 24, and the amplitude spectral data SD48 of the pseudo-noise signal S48 supplied from the Fourier transformer 25. Specifically, in the period during which the flag signal CTL is at the low level (inactive), the noise model selector 27 selects one of the multiple noise models NM by calculating similarity between the amplitude spectral data SD38 of the sound source signal S38 and each of the multiple noise models NM. More specifically, during the period during which the flag signal CTL is at the low level (inactive), the sound source signal S38 includes no signal component of the user's elected sound source (the target sound source); therefore, in this period, the noise model selector 27 selects one of the multiple noise models NM, based on the amplitude spectral data SD38 of the sound source signal S38. For example, the similarity may be cosine similarity. The noise model selector 27 selects one noise model NM that is highest in similarity, for example, from among the multiple noise models NM. Further, in the period during which the flag signal CTL is at the high level (active), the noise model selector 27 selects one of the multiple noise models NM by calculating similarity between the amplitude spectral data SD48 of the pseudo-noise signal S48 and each of the multiple noise models NM. More specifically, during the period during which the flag signal CTL is at the high level (active), the sound source signal S38 includes the signal component of the user's elected sound source (the target sound source); therefore, in this period, the noise model selector 27 selects one of the multiple noise models NM, based on the amplitude spectral data SD48 of the pseudo-noise signal S48. The noise model selector 27 selects one noise model NM that is highest in similarity, for example, from among the multiple noise models NM. Thereafter, the noise model selector 27 supplies the noise model NM thus selected to the spectral subtractor 28.

The spectral subtractor 28 is configured to perform spectral subtraction processing of subtracting the amplitude spectral data of the noise model NM supplied from the noise model selector 27 from the amplitude spectral data SD38 of the sound source signal S38 supplied from the Fourier transformer 24. Thereafter, the spectral subtractor 28 supplies the amplitude spectral data obtained through the spectral subtraction processing to the inverse Fourier transformer 29.

The inverse Fourier transformer 29 is configured to generate the signal S29 by performing inverse transformation of the discrete Fourier transform, based on the amplitude spectral data supplied from the spectral subtractor 28 and the phase spectral data SDP supplied from the Fourier transformer 24.

In this way, the noise processing circuit 20 generates the signal S29 of a time domain with reduced noise. Thereafter, the noise processing circuit 20 supplies the signal S29 to the processing circuit 19 positioned to follow the noise processing circuit 20.

The processing circuit 19 is configured to perform predetermined signal processing, based on the signal S29.

Here, the sound source detector 21 corresponds to a specific example of a “detector” in one embodiment of the disclosure. The microphones 91 to 94 correspond to a specific example of “multiple microphones” in one embodiment of the disclosure. The signals S11 to S14 correspond to a specific example of “multiple signals” in one embodiment of the disclosure. The sound source selector 22 corresponds to a specific example of a “flag signal generator” in one embodiment of the disclosure. The beamforming processor 30 corresponds to a specific example of a “beamforming processor” in one embodiment of the disclosure. The noise model generator 26 corresponds to a specific example of a “noise model generator” in one embodiment of the disclosure. The noise model selector 27 corresponds to a specific example of a “noise model selector” in one embodiment of the disclosure. The spectral subtractor 28 corresponds to a specific example of a “spectral subtractor” in one embodiment of the disclosure. The user interface 18 corresponds to a specific example of a “user interface” in one embodiment of the disclosure. The processing circuit 19 corresponds to a specific example of a “processing circuit” in one embodiment of the disclosure.

### Operation and Workings

Next, a description will be given of operation and workings of the signal processing device 1 of the present example embodiment.

### Outline of Overall Operation

First, an outline of overall operation of the signal processing device 1 will be described with reference to FIG. 1. The microphones 91 to 94 convert sound waves into respective electric signals. The AD conversion circuits 11 to 14 respectively generate the signals S11 to S14 by performing the AD conversion, based on the respective electric signals supplied from the microphones 91 to 94. The user interface 18 presents information to the user of the signal processing device 1 and receives a user operation. The noise processing circuit 20 generates the signal S29 with reduced noise, by performing noise processing based on the signals S11 to S14.

Based on the signals S11 to S14, the sound source detector 21 of the noise processing circuit 20 detects the kind of the sound source and generates metadata indicating the kind of the sound source. Based on the metadata supplied from the sound source detector 21 and information on the user's selection operation supplied from the user interface 18, the sound source selector 22 generates the flag signal CL that is to be made active in the period during which the signals S11 to S14 each include the signal component of the user's selected sound source, and made inactive in the other periods. The beamforming processor 30 generates the sound source signal S38 and the pseudo-noise signal S48, based on the signals S11 to S14 and the flag signal CTL. The Fourier transformer 24 calculates the amplitude spectral data SD38 and the phase spectral data SDP of the sound source signal S38 by performing a discrete Fourier transform, based on the sound source signal S38. The Fourier transformer 25 calculates the amplitude spectral data SD48 of the pseudo-noise signal S48 by performing a discrete Fourier transform, based on the pseudo-noise signal S48. The noise model generator 26 generates the noise model NM, based on the flag signal CTL and the amplitude spectral data SD38 of the sound source signal S38. The noise model selector 27 accumulates multiple noise models NM supplied from the noise model generator 26, and selects one noise model NM from among the accumulated noise models NM, based on the flag signal CTL, the amplitude spectral data SD38 of the sound source signal S38, and the amplitude spectral data SD48 of the pseudo-noise signal S48. The spectral subtractor 28 performs the spectral subtraction processing of subtracting the amplitude spectral data of the noise model NM supplied from the noise model selector 27 from the amplitude spectral data SD38 of the sound source signal S38. The inverse Fourier transformer 29 generates the signal S29 by performing inverse transformation of the discrete Fourier transform, based on the amplitude spectral data supplied from the spectral subtractor 28 and the phase spectral data SDP supplied from the Fourier transformer 24.

The processing circuit 19 performs the predetermined signal processing, based on the signal S29 generated by the noise processing circuit 20.

### Detailed Operation

Next, a description will be given in detail of the operation of each of the noise model generator 26 and the noise model selector 27 in the noise processing circuit 20.

### Operation of Noise Model Generator 26

The noise model generator 26 generates the noise model NM, based on the flag signal CTL and the amplitude spectral data SD38 of the sound source signal S38 that is supplied from the Fourier transformer 24.

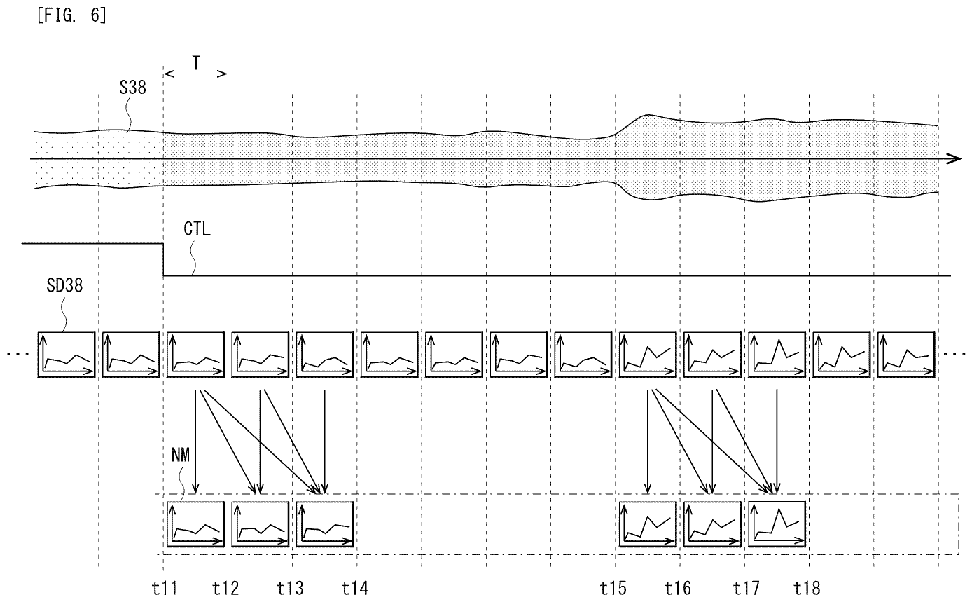

FIG. 6 illustrates an operation example of the noise model generator 26. In FIG. 6, the sound source signal S38 is illustrated using envelopes.

In this example, the sound source selector 22 changes the flag signal CTL from the high level (active) to the low level (inactive) at the timing t11. In other words, the sound source signal S38 includes the signal component of the user's selected sound source during a period before the timing t11, and includes no signal component of the user's selected sound source during a period after the timing t11.

In each processing period T, the Fourier transformer 24 calculates the amplitude spectral data SD38 of the sound source signal S38 by performing a discrete Fourier transform, based on the predetermined number of (e.g., 512) pieces of data e included in the sound source signal S38.

In the periods during which the flag signal CTL is at the low level (inactive), the noise model generator 26 generates the noise models NM, based on the amplitude spectral data SD38 of the sound source signal S38 supplied from the Fourier transformer 24.

Specifically, for example, the noise model generator 26 generates the noise model NM, based on the amplitude spectral data SD38 obtained based on the sound source signal S38 in a period from the timing t11 to the timing t12. For example, the noise model generator 26 may generate the noise model NM by multiplying the amplitude spectral data SD38 by a coefficient. The coefficient is what is called a subtraction coefficient. Specifically, for example, the noise model generator 26 may generate the noise model NM by multiplying the magnitude of the amplitude of the amplitude spectral data SD38 at each frequency by “1.3”. This is non-limiting, and the noise model generator 26 may generate the noise model NM by multiplying the magnitude of the amplitude of the amplitude spectral data SD38 at each frequency by “1.0”, or by “0.7”, for example.

Thereafter, the noise model generator 26 generates the noise model NM, based on, in this example, the amplitude spectral data SD38 obtained based on the sound source signal S38 in the period from the timing t11 to the timing t12 and the amplitude spectral data SD38 obtained based on the sound source signal S38 in a period from the timing t12 to the timing t13. The noise model generator 26 may generate the noise model NM by, for example, calculating an average value of these two pieces of amplitude spectral data SD38. Alternatively, the noise model generator 26 may generate the noise model NM by, for example, performing a weighted addition using a coefficient, based on these two pieces of amplitude spectral data SD38.

Thereafter, the noise model generator 26 generates the noise model NM, based on, in this example, the amplitude spectral data SD38 obtained based on the sound source signal S38 in the period from the timing t11 to the timing t12, the amplitude spectral data SD38 obtained based on the sound source signal S38 in the period from the timing t12 to the timing t13, and the amplitude spectral data SD38 obtained based on the sound source signal S38 in a period from the timing t13 to the timing t14. The noise model generator 26 may generate the noise model NM by, for example, calculating an average value of these three pieces of amplitude spectral data SD38. Alternatively, the noise model generator 26 may generate the noise model NM by, for example, performing a weighted addition using a coefficient, based on these three pieces of amplitude spectral data SD38.

In this example, the noise model generator 26 refrains from generating the noise model NM during a period from the timing t14 to the timing t15. More specifically, the noise model generator 26 refrains from generating the noise model NM because, in this example, four pieces of amplitude spectral data SD38 in the period from the timing t14 to the timing t15 are each substantially the same as any of the pieces of the amplitude spectral data SD38 in the period from the timing t11 to the timing t14. Note that although no noise model NM is generated during the period from the timing t14 to the timing t15 in this example, this is non-limiting, and the noise model NM may be generated in this period.

Thereafter, in this example, the sound source signal S38 greatly changes at the timing t15. Accordingly, the amplitude spectral data SD38 also greatly changes.

The noise model generator 26 generates the noise model NM, based on the amplitude spectral data SD38 obtained based on the sound source signal S38 in a period from the timing t15 to a timing t16. More specifically, in this example, the noise model generator 26 generates the noise model NM because the amplitude spectral data SD38 in the period from the timing t15 to the timing t16 exhibits a change greater than or equal to a predetermined degree relative to the previous amplitude spectral data SD38, for example. The noise model generator 26 may generate the noise model NM by, for example, multiplying the amplitude spectral data SD38 by a coefficient. More specifically, in this example, the amplitude spectral data SD38 in the period from the timing t15 to the timing t16 has a low correlation with the amplitude spectral data SD38 in the preceding periods; therefore, the noise model generator 26 generates the noise model NM, based on the amplitude spectral data SD38 in the period from the timing t15 to the timing t16, without using the amplitude spectral data SD38 in the preceding periods.

Thereafter, in this example, the noise model generator 26 generates the noise model NM, based on the amplitude spectral data SD38 obtained based on the sound source signal S38 in the period from the timing t15 to the timing t16 and the amplitude spectral data SD38 obtained based on the sound source signal S38 in a period from the timing t16 to a timing t17.

Thereafter, in this example, the noise model generator 26 generates the noise model NM, based on the amplitude spectral data SD38 obtained based on the sound source signal S38 in the period from the timing t15 to the timing t16, the amplitude spectral data SD38 obtained based on the sound source signal S38 in the period from the timing t16 to the timing t17, and the amplitude spectral data SD38 obtained based on the sound source signal S38 in a period from the timing t17 to a timing t18.

In this way, the noise model generator 26 generates the noise models NM in the periods during which the flag signal CTL is at the low level (inactive), based on the amplitude spectral data SD38 of the sound source signal S38 supplied from the Fourier transformer 24.

Note that in this example, the noise model generator 26 generates the noise models NM immediately after the flag signal CTL changes from the high level (active) to the low level (inactive) and when the amplitude spectral data SD38 greatly changes; however, this is non-limiting, and the noise model generator 26 may generate the noise models NM in other cases. For example, the noise model generator 26 may generate the noise models NM constantly when the flag signal CTL is at the low level (inactive).

In this way, the noise model generator 26 generates the noise models NM, based on the amplitude spectral data SD38 of the sound source signal S38 supplied from the Fourier transformer 24. Thereafter, the noise model generator 26 supplies the generated noise models NM sequentially to the noise model selector 27.

### Operation of Noise Model Selector 27

The noise model selector 27 accumulates the noise models NM supplied from the noise model generator 26, and selects one of the accumulated noise models NM, based on the flag signal CTL, the amplitude spectral data SD38 of the sound source signal S38, and the amplitude spectral data SD48 of the pseudo-noise signal S48.

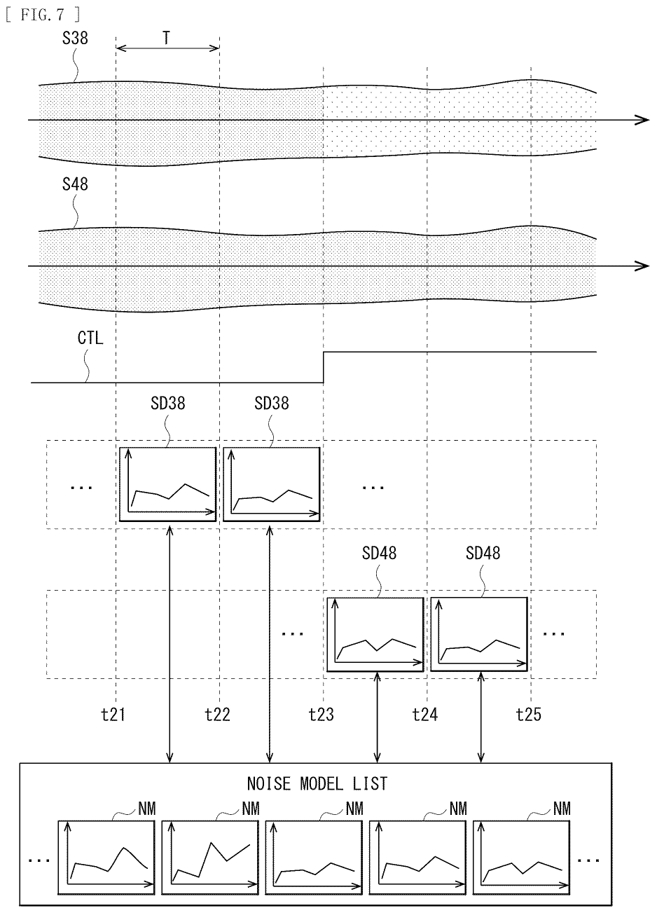

FIG. 7 illustrates an operation example of the noise model selector 27. In FIG. 7, a noise model list indicates multiple noise models NM generated by the noise model generator 26 and accumulated by the noise model selector 27.

In this example, the sound source selector 22 changes the flag signal CTL from the low level (inactive) to the high level (active) at a timing t23. In other words, the sound source signal S38 includes no signal component of the user's selected sound source (the target sound source) during a period before the timing t23, and includes the signal component of the user's selected sound source during a period after the timing t23.

In each processing period T, the Fourier transformer 24 calculates the amplitude spectral data SD38 of the sound source signal S38 by performing a discrete Fourier transform, based on the predetermined number of (e.g., 512) pieces of data e included in the sound source signal S38. Similarly, in each processing period T, the Fourier transformer 25 calculates the amplitude spectral data SD48 of the pseudo-noise signal S48 by performing a discrete Fourier transform, based on the predetermined number of (e.g., 512) pieces of data e included in the pseudo-noise signal S48.

In the period during which the flag signal CTL is at the low level (inactive), the noise model selector 27 selects one noise model NM from among the multiple noise models NM by calculating similarity between the amplitude spectral data SD38 of the sound source signal S38 and each of the multiple noise models NM accumulated. Thereafter, the noise model selector 27 supplies the noise model NM thus selected to the spectral subtractor 28.

Specifically, for example, the noise model selector 27 calculates similarity between the amplitude spectral data SD38 obtained based on the sound source signal S38 in a period from a timing t21 to a timing t22 and each of the multiple noise models NM. The noise model selector 27 selects one noise model NM that is highest in similarity, for example, from among the multiple noise models NM. Thereafter, the noise model selector 27 supplies the noise model NM thus selected to the spectral subtractor 28.

Thereafter, the noise model selector 27 calculates similarity between the amplitude spectral data SD38 obtained based on the sound source signal S38 in a period from the timing t22 to the timing t23 and each of the multiple noise models NM. The noise model selector 27 selects one noise model NM that is highest in similarity, for example, from among the multiple noise models NM. Thereafter, the noise model selector 27 supplies the noise model NM thus selected to the spectral subtractor 28.

In the period during which the flag signal CTL is at the high level (active), the noise model selector 27 selects one noise model NM from among the multiple noise models NM by calculating similarity between the amplitude spectral data SD48 of the pseudo-noise signal S48 and each of the multiple noise models NM. Thereafter, the noise model selector 27 supplies the noise model NM thus selected to the spectral subtractor 28.

Specifically, for example, the noise model selector 27 calculates similarity between the amplitude spectral data SD48 obtained based on the pseudo-noise signal S48 in a period from the timing t23 to a timing t24 and each of the multiple noise models NM. The noise model selector 27 selects one noise model NM that is highest in similarity, for example, from among the multiple noise models NM. Thereafter, the noise model selector 27 supplies the noise model NM thus selected to the spectral subtractor 28.

Thereafter, the noise model selector 27 calculates similarity between the amplitude spectral data SD48 obtained based on the pseudo-noise signal S48 in a period from the timing t24 to a timing t25 and each of the multiple noise models NM. The noise model selector 27 selects one noise model NM that is highest in similarity, for example, from among the multiple noise models NM. Thereafter, the noise model selector 27 supplies the noise model NM thus selected to the spectral subtractor 28.

The spectral subtractor 28 performs the spectral subtraction processing of subtracting the amplitude spectral data of the noise model NM supplied from the noise model selector 27 from the amplitude spectral data SD38 of the sound source signal S38 supplied from the Fourier transformer 24. Thereafter, the inverse Fourier transformer 29 generates the signal S29 by performing inverse transformation of the discrete Fourier transform, based on the amplitude spectral data supplied from the spectral subtractor 28 and the phase spectral data SDP supplied from the Fourier transformer 24.

In this way, the noise processing circuit 20 generates the signal S29 of the time domain with reduced noise.

As described above, the noise processing circuit 20 includes the sound source detector 21, the sound source selector 22, the beamforming processor 30, the noise model generator 26, the noise model selector 27, and the spectral subtractor 28. The sound source detector 21 detects a sound source, based on the four signals S11 to S14 supplied from the four microphones 91 to 94. The sound source selector 22 generates, based on a result of detecting by the sound source detector 21, the flag signal CTL indicating the period during which the four signals S11 to S14 each include a first signal component (in this example, a signal component of the sound source selected by the user). The beamforming processor 30 generates, based on the four signals S11 to S14 and the flag signal CTL, the sound source signal S38 by emphasizing the first signal component in the period during which the four signals S11 to S14 each include the first signal component, and the pseudo-noise signal S48 by de-emphasizing the first signal component in the period during which the four signals S11 to S14 each include the first signal component. The noise model generator 26 generates, based on the flag signal CTL, the multiple noise models NM in the period during which the four signals S11 to S14 each do not include the first signal component, the multiple noise models NM each corresponding to the spectrum of the sound source signal S38. The noise model selector 27 selects one noise model NM from among the multiple noise models NM by selecting, based on the flag signal CTL, one of the sound source signal S38 or the pseudo-noise signal S48 and by calculating similarity in spectrum between the one of the sound source signal S38 or the pseudo-noise signal S48 selected and each of the multiple noise models NM. The spectral subtractor 28 performs the spectral subtraction processing, based on the spectrum of the sound source signal S38 and the noise model NM selected by the noise model selector 27. This makes it possible for the noise processing circuit 20 to effectively reduce non-stationary noise.

To be more specific, it is possible to reduce stationary noise by a typical spectral subtraction method; however, non-stationary noise is difficult to reduce by such a method. Specifically, for example, a noise processing circuit may acquire a noise spectrum based on stationary noise and subtract the acquired noise spectrum from a spectrum of a sound source signal. This makes it possible to reduce the stationary noise included in the sound source signal. However, when the sound source signal includes non-stationary noise, the above-described technique may not help to reduce the non-stationary noise, and can result in loss of quality of a desired signal component. Alternatively, the noise processing circuit may acquire a noise spectrum based on non-stationary noise and subtract the acquired noise spectrum from the spectrum of the sound source signal. This makes it possible to reduce the non-stationary noise included in the sound source signal; however, when the sound source signal does not include any non-stationary noise, the quality of the desired signal component can suffer.

In contrast, in the noise processing circuit 20 according to the present example embodiment, the multiple noise models NM are provided and one of the multiple noise models NM is selected by calculating similarity in spectrum between one of the sound source signal S38 or the pseudo-noise signal S48 and each of the multiple noise models NM. Further, the spectrum subtraction processing is performed based on the spectrum of the sound source signal S38 and the noise model NM selected by the noise model selector 27. As a result, for example, in the period during which the sound source signal S38 includes no signal component of the user's selected sound source, one noise model NM similar to the spectrum of the sound source signal S38 is selected. Further, for example, in the period during which the sound source signal S38 includes the signal component of the user's selected sound source, one noise model NM similar to the spectrum of the pseudo-noise signal S48 is selected. The pseudo-noise signal S48 has a correlation with a noise component included in the sound source signal S38. Accordingly, regardless of whether or not the sound source signal S38 includes non-stationary noise, one noise model NM that allows for reduction of the noise included in the sound source signal S38 is selected from among the multiple noise models NM. This makes it possible for the noise processing circuit 20 to reduce non-stationary noise, without loss of the quality of the desired signal component. As a result, it is possible to effectively reduce the non-stationary noise.

Further, in the noise processing circuit 20, the sound source detector 21 generates, by detecting the sound source, a sequence of metadata indicating the kind of the sound source, and the sound source selector 22 generates the flag signal CTL, based on the sequence of the metadata. This makes it possible for the noise processing circuit 20 to reduce a possibility of performing noise processing based on an unintended signal component. Accordingly, it is possible to enhance the accuracy of noise processing.

Further, in the noise processing circuit 20, the sound source selector 22 generates the flag signal CTL, based on the result of detecting by the sound source detector 21 and the user's sound source selection operation received by the user interface 18. The user is thus allowed to select what sound source the signal component of which is to be retained with the other signal components reduced, in accordance with the application. This makes it possible for the noise processing circuit 20 to perform noise processing based on a signal component intended by the user. Accordingly, it is possible to enhance the accuracy of the noise processing.

Further, in the noise processing circuit 20, based on the flag signal CTL, in the period during which the four signals S11 to S14 each include the first signal component (in this example, the signal component of the user's selected sound source), the beamforming processor 30 adjusts a first processing setting (in this example, the delay amounts d1 to d4 of the four delayers 31 to 34 and the filter coefficients of the three adaptive filters 44 to 46) of the beamforming processor 30 to generate the sound source signal S38 in which the first signal component is emphasized, and, in the period during which the four signals S11 to S14 each do not include the first signal component, the beamforming processor 30 retains the first processing setting and generates the sound source signal S38 by using the first processing setting. This makes it possible to generate the sound source signal S38 in which the signal component of the user's selected sound source is emphasized, regardless of the direction of the sound source as viewed from the signal processing device 1 or characteristic differences between the microphones 91 to 94, for example. Accordingly, it is possible for the noise processing circuit 20 to enhance the accuracy of the noise processing.

Further, in the noise processing circuit 20, based on the flag signal CTL, in the period during which the four signals S11 to S14 each do not include the first signal component (in this example, the signal component of the user's selected sound source), the beamforming processor 30 adjusts a second processing setting (in this example, the filter coefficients of the three adaptive filters 44 to 46) of the beamforming processor 30 to de-emphasize a second signal component (e.g., the noise component) of the sound source signal S38 and generate the pseudo-noise signal S48 including the second signal component, and, in the period during which the four signals S11 to S14 each include the first signal component, the beamforming processor 30 retains the second processing setting and generates the pseudo-noise signal S48 by using the second processing setting. This makes it possible to generate the pseudo-noise signal S48 that includes the noise components included in the signals S11 to S14, with the signal component of the user's selected sound source de-emphasized, regardless of the direction of the sound source or characteristic differences between the microphones 91 to 94, for example. Accordingly, it is possible for the noise processing circuit 20 to enhance the accuracy of the noise processing.

Further, in the noise processing circuit 20, when the spectrum of the sound source signal S38 exhibits a change greater than or equal to a predetermined degree, the noise model generator 26 generates the noise model NM corresponding to the spectrum after the change. This makes it possible for the noise processing circuit 20 to reduce, even when new non-stationary noise occurs, a noise component of the non-stationary noise in the sound source signal S38. Accordingly, it is possible to effectively reduce the non-stationary noise.

Further, in the noise processing circuit 20, based on the flag signal CTL, in the period during which the four signals S11 to S14 each do not include the first signal component (in this example, the signal component of the user's selected sound source), the noise model selector 27 selects the sound source signal S38, out of the sound source signal S38 and the pseudo-noise signal S48, and selects one noise model NM from among the multiple noise models NM, based on the sound source signal S38. This makes it possible for the noise processing circuit 20 to enhance the accuracy of the noise processing. More specifically, during the above-described period, the sound source signal S38 includes no signal component of the user's selected sound source, and therefore it is possible to obtain a spectrum of noise with high accuracy, based on the sound source signal S38, and to select a more suitable one of the multiple noise models NM. As a result, it is possible for the noise processing circuit 20 to enhance the accuracy of the noise processing.

Further, in the noise processing circuit 20, based on the flag signal CTL, when the four signals S11 to S14 each include the first signal component (in this example, the signal component of the user's selected sound source), the noise model selector 27 selects the pseudo-noise signal S48, out of the sound source signal S38 and the pseudo-noise signal S48, and selects one noise model NM from among the multiple noise models NM, based on the pseudo-noise signal S48. This makes it possible for the noise processing circuit 20 to enhance the accuracy of the noise processing. More specifically, during the above-described period, the sound source signal S38 includes the signal component of the user's selected sound source, and therefore it is difficult to obtain the spectrum of noise with high accuracy, based on the sound source signal S38. The signal component of the pseudo-noise signal S48 has a correlation with the noise component included in the sound source signal S38. Accordingly, by obtaining the spectrum of noise based on the pseudo-noise signal S48, it is possible to select a more suitable one of the multiple noise models NM. As a result, it is possible for the noise processing circuit 20 to enhance the accuracy of the noise processing.

### Effects

As described above, the sound source detector, the sound source selector, the beamforming processor, the noise model generator, the noise model selector, and the spectral subtractor are provided in the present example embodiment. The sound source detector detects the sound source, based on the four signals supplied from the four microphones. The sound source selector generates, based on the result of detecting by the sound source detector, the flag signal that indicates the period during which the four signals each include the first signal component. The beamforming processor generates, based on the four signals and the flag signal, the sound source signal by emphasizing the first signal component in the period during which the four signals each include the first signal component, and the pseudo-noise signal by de-emphasizing the first signal component in the period during which the four signals each include the first signal component. The noise model generator generates, based on the flag signal, the multiple noise models in the period during which the multiple signals each do not include the first signal component, the multiple noise models each corresponding to the spectrum of the sound source signal. The noise model selector selects one noise model from among the multiple noise models by selecting, based on the flag signal CTL, one of the sound source signal or the pseudo-noise signal and by calculating similarity in spectrum between the one of the sound source signal or the pseudo-noise signal selected and each of the multiple noise models. The spectral subtractor performs the spectral subtraction processing, based on the spectrum of the sound source signal and the one noise model selected by the noise model selector. Accordingly, it is possible to effectively reduce non-stationary noise.

In the present example embodiment, the sound source detector generates the sequence of metadata by detecting the sound source, the metadata indicating the kind of the sound source, and the sound source selector generates the flag signal, based on the sequence of the metadata. This makes it possible to enhance the accuracy of noise processing.

In the present example embodiment, the sound source selector generates the flag signal, based on the result of detecting by the sound source detector and the user's sound source selection operation received by the user interface. This makes it possible to enhance the accuracy of the noise processing.

In the present example embodiment, based on the flag signal, in the period during which the four signals each include the first signal component, the beamforming processor adjusts the first processing setting of the beamforming processor to generate the sound source signal in which the first signal component is emphasized, and, in the period during which the four signals each do not include the first signal component, the beamforming processor retains the first processing setting and generates the sound source signal by using the first processing setting. This makes it possible to enhance the accuracy of the noise processing.

In the present example embodiment, based on the flag signal, in the period during which the four signals each do not include the first signal component, the beamforming processor adjusts the second processing setting of the beamforming processor to de-emphasize the second signal component of the sound source signal and to generate the pseudo-noise signal including the second signal component, and, in the period during which the four signals each include the first signal component, the beamforming processor retains the second processing setting and generates the pseudo-noise signal by using the second processing setting. This makes it possible to enhance the accuracy of the noise processing.

In the present example embodiment, when the spectrum of the sound source signal exhibits a change greater than or equal to a predetermined degree, the noise model generator generates a noise model corresponding to the spectrum after the change. This makes it possible to effectively reduce non-stationary noise.

In the present example embodiment, based on the flag signal, in the period during which the four signals each do not include the first signal component, the noise model selector selects the sound source signal, out of the sound source signal and the pseudo-noise signal, and selects the one noise model from among the multiple noise models, based on the sound source signal. This makes it possible to enhance the accuracy of the noise processing.

In the present example embodiment, based on the flag signal, when the four signals each include the first signal component, the noise model selector selects the pseudo-noise signal, out of the sound source signal and the pseudo-noise signal, and selects the one noise model from among the multiple noise models, based on the pseudo-noise signal. This makes it possible to enhance the accuracy of the noise processing.

### Modification Example 1

In the foregoing example embodiment, the beamforming processor 30 has the configuration illustrated in FIG. 4; however, this is non-limiting. In the following, the present modification example will be described with reference to some examples.

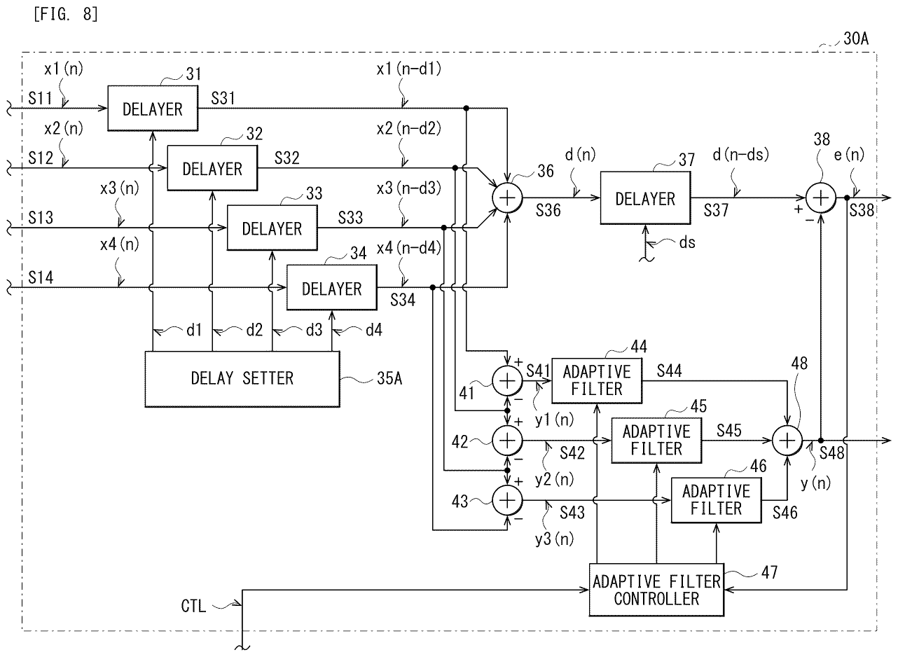

FIG. 8 illustrates a configuration example of a beamforming processor 30A according to the present modification example. The beamforming processor 30A includes the delayers 31 to 34, a delay setter 35A, the adder 36, the delayer 37, the subtractors 41 to 43, the adaptive filters 44 to 46, the adaptive filter controller 47, the adder 48, and the subtractor 38. In other words, the beamforming processor 30A corresponds to the beamforming processor 30 (FIG. 4) according to the foregoing example embodiment in which the delay controller 35 is replaced with the delay setter 35A. The delay setter 35A is configured to set the respective delay amounts d1 to d4 of the delayers 31 to 34. In the delay setter 35A, the delay amounts d1 to d4 are set in advance, based on the direction of the sound source as viewed from the signal processing device 1 or the characteristic differences between the microphones 91 to 94. The delay setter 35A holds setting data on the delay amounts d1 to d4. The delay setter 35A may hold multiple pieces of such setting data and allow one of the pieces of the setting data to be selected based on, for example, a user operation. The delay setter 35A sets the delay amounts d1 to d4, based on the setting data. In this case also, it is possible to obtain effects similar to those in the case of the foregoing example embodiment.

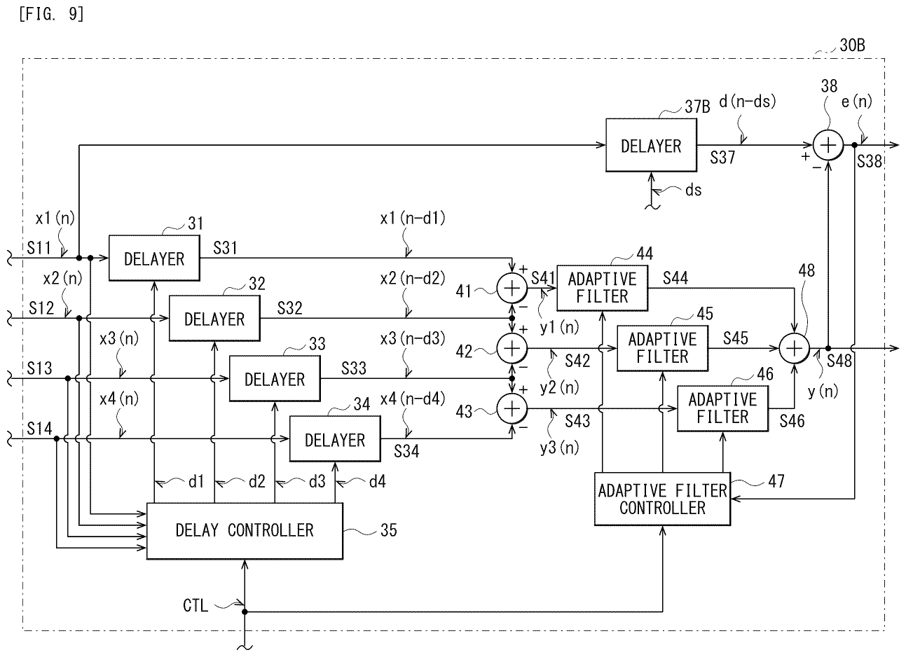

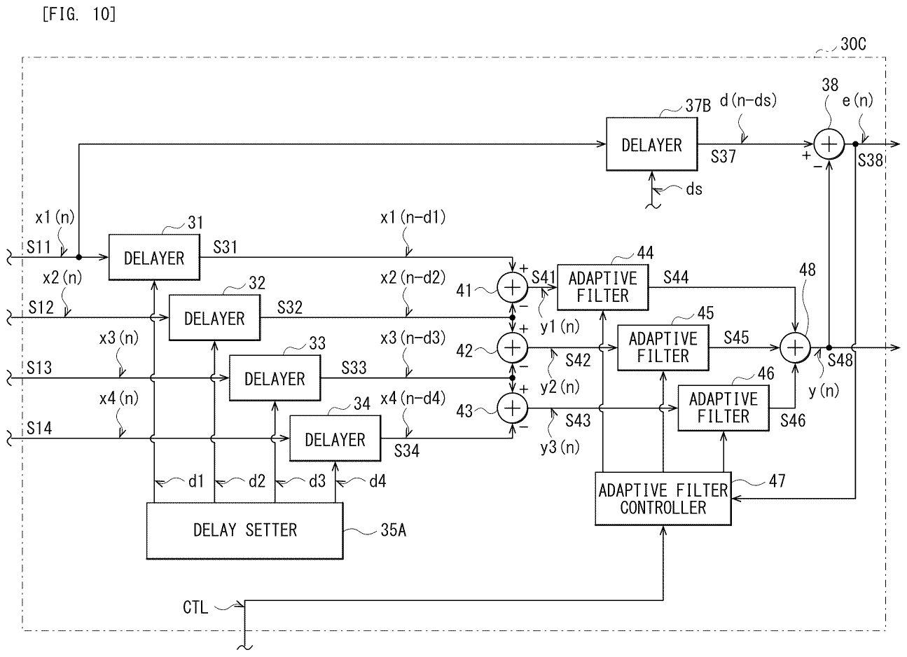

FIG. 9 illustrates a configuration example of a beamforming processor 30B according to the present modification example. The beamforming processor 30B includes the delayers 31 to 34, the delay controller 35, a delayer 37B, the subtractors 41 to 43, the adaptive filters 44 to 46, the adaptive filter controller 47, the adder 48, and the subtractor 38. In other words, the beamforming processor 30B corresponds to the beamforming processor 30 (FIG. 4) according to the foregoing example embodiment from which the adder 36 is omitted and in which the delayer 37 is replaced with the delayer 37B. The delayer 37B is configured to generate the signal S37 by delaying the signal S11 by the delay amount ds. Note that this is non-limiting, and the delayer 37B may generate the signal S37 by delaying any one of the signals S12 to S14 by the delay amount ds. The delay amount ds of the delayer 37B is of a predetermined value set by an unillustrated controller. In this case also, the noise component included in the signal S37 is reduced by subtraction, by the subtractor 38, of the pseudo-noise signal S48 from the signal S37. This makes it possible for the beamforming processor 30B to generate the sound source signal S38 that is a signal in which the signal component of the user's selected sound source is emphasized. In this case also, it is possible to obtain effects similar to those in the case of the foregoing example embodiment.

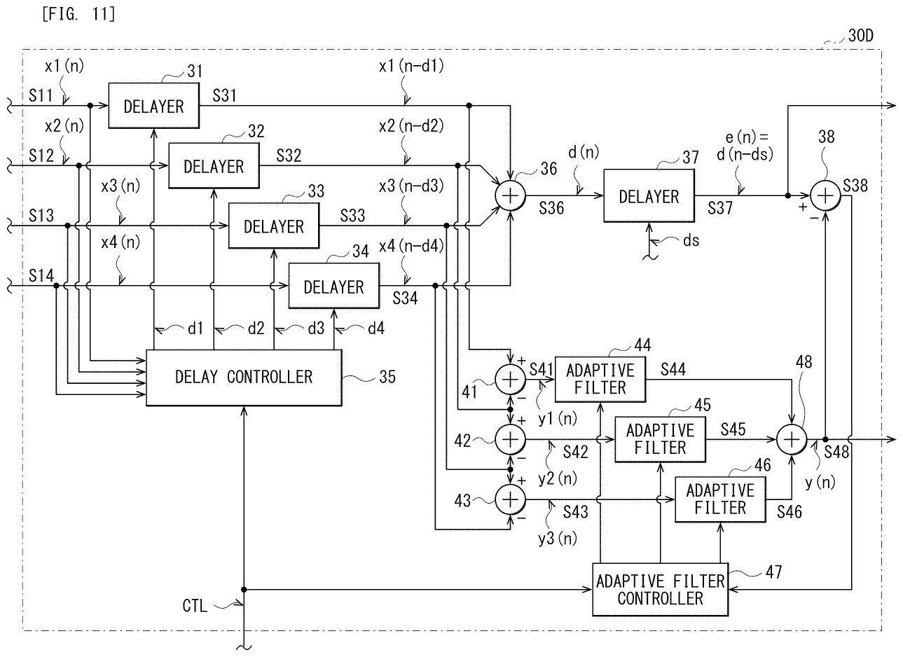

FIG. 10 illustrates a configuration example of a beamforming processor 30C according to the present modification example. The beamforming processor 30C results from combining the beamforming processor 30A illustrated in FIG. 8 and the beamforming processor 30B illustrated in FIG. 9 together. The beamforming processor 30C includes the delayers 31 to 34, the delay setter 35A, the delayer 37B, the subtractors 41 to 43, the adaptive filters 44 to 46, the adaptive filter controller 47, the adder 48, and the subtractor 38. In other words, the beamforming processor 30C corresponds to the beamforming processor 30 (FIG. 4) according to the foregoing example embodiment from which the adder 36 is omitted and in which the delay controller 35 and the delayer 37 are replaced with the delayer setter 35A and the delayer 37B, respectively. In this case also, it is possible to obtain effects similar to those in the case of the foregoing example embodiment.

### Modification Example 2

In the foregoing example embodiment, the beamforming processor 30 outputs an output signal of the subtractor 38 as the sound source signal S38; however, this is non-limiting. Alternatively, as in a beamforming processor 30D illustrated in FIG. 11, the signal S37 that the delayer 37 outputs may be outputted as the sound source signal. In this case also, the adder 36 adds up the signals S31 to S34 whose signal components of the user's selected sound source are in phase with each other. Accordingly, it is possible for the beamforming processor 30D to output the signal in which the signal component of the user's selected sound source is emphasized, as the sound source signal.

### Other Modification Examples

Further, two or more of these modification examples may be combined.

The disclosure has been described hereinabove with reference to the example embodiment and the modification examples. However, the disclosure is not limited to the example embodiment, etc., and may be modified in a variety of ways.

For example, in the foregoing example embodiment, etc., the four microphones 91 to 94 are provided; however, this is non-limiting. Alternatively, two or three microphones may be provided, or five or more microphones may be provided.

The effects described in the present specification are merely examples, and effects of the disclosure are not limited to the effects described in the present specification. Accordingly, the disclosure may achieve any other effect.

The disclosure may further encompass the following embodiments.

### 1

A noise processing circuit including:
a detector configured to detect a sound source, based on multiple signals supplied from multiple microphones;
a flag signal generator configured to generate, based on a result of detecting by the detector, a flag signal that indicates a period during which the multiple signals each include a first signal component;
a beamforming processor configured to generate, based on the multiple signals and the flag signal, a first signal by emphasizing the first signal component in the period during which the multiple signals each include the first signal component, and a second signal by de-emphasizing the first signal component in the period during which the multiple signals each include the first signal component;
a noise model generator configured to generate, based on the flag signal, multiple noise models in a period during which the multiple signals each do not include the first signal component, the multiple noise models each corresponding to a spectrum of the first signal;
a noise model selector configured to select one noise model from among the multiple noise models by selecting, based on the flag signal, one of the first signal or the second signal and by calculating similarity in spectrum between the one of the first signal or the second signal selected and each of the multiple noise models; and
a spectral subtractor configured to perform spectral subtraction processing, based on the spectrum of the first signal and the one noise model selected by the noise model selector.

### 2

The noise processing circuit according to (1), in which
the detector is configured to generate a sequence of metadata by detecting the sound source, the metadata indicating a kind of the sound source, and
the flag signal generator is configured to generate the flag signal, based on the sequence of the metadata.

### 3

The noise processing circuit according to (1) or (2), in which the flag signal generator is configured to generate the flag signal, based on the result of the detecting by the detector and a user's sound source selection operation received by a user interface.

### 4

The noise processing circuit according to any one of (1) to (3), in which
the beamforming processor is configured to, based on the flag signal,
   in the period during which the multiple signals each include the first signal component, adjust a first processing setting of the beamforming processor to generate the first signal in which the first signal component is emphasized, and
   in the period during which the multiple signals each do not include the first signal component, retain the first processing setting and generate the first signal by using the first processing setting.

### 5

The noise processing circuit according to any one of (1) to (4), in which
the beamforming processor is configured to, based on the flag signal,
   in the period during which the multiple signals each do not include the first signal component, adjust a second processing setting of the beamforming processor to de-emphasize a second signal component of the first signal and to generate the second signal including the second signal component, and
   in the period during which the multiple signals each include the first signal component, retain the second processing setting and generate the second signal by using the second processing setting.

### 6

The noise processing circuit according to any one of (1) to (5), in which
the noise model generator is configured to generate a first noise model, based on the spectrum of the first signal in a first period, and
the multiple noise models include the first noise model.

### 7

The noise processing circuit according to any one of (1) to (6), in which
the noise model generator is configured to generate a second noise model, based on the spectrum of the first signal in a first period and the spectrum of the first signal in a second period, and
the multiple noise models include the second noise model.

### 8

The noise processing circuit according to any one of (1) to (7), in which
the noise model generator is configured to, when the spectrum of the first signal exhibits a change greater than or equal to a predetermined degree, generate a third noise model corresponding to the spectrum after the change, and
the multiple noise models include the third noise model.

### 9

The noise processing circuit according to any one of (1) to (8), in which
the noise model selector is configured to, based on the flag signal, in the period during which the multiple signals each do not include the first signal component, select the first signal, out of the first signal and the second signal, and select the one noise model from among the multiple noise models, based on the first signal.

### 10

The noise processing circuit according to any one of (1) to (9), in which
the noise model selector is configured to, based on the flag signal, in the period during which the multiple signals each include the first signal component, select the second signal, out of the first signal and the second signal, and select the one noise model from among the multiple noise models, based on the second signal.

### 11

A signal processing device including
a noise processing circuit configured to perform noise processing, based on multiple signals supplied from multiple microphones, and
a processing circuit configured to perform signal processing, based on a result of processing by the noise processing circuit, in which
the noise processing circuit includes:
   a detector configured to detect a sound source, based on the multiple signals supplied from the multiple microphones;
   a flag signal generator configured to generate, based on a result of detecting by the detector, a flag signal that indicates a period during which the multiple signals each include a first signal component;
   a beamforming processor configured to generate, based on the multiple signals and the flag signal, a first signal by emphasizing the first signal component in the period during which the multiple signals each include the first signal component, and a second signal by de-emphasizing the first signal component in the period during which the multiple signals each include the first signal component;
   a noise model generator configured to generate, based on the flag signal, multiple noise models in a period during which the multiple signals each do not include the first signal component, the multiple noise models each corresponding to a spectrum of the first signal;
a noise model selector configured to select one noise model from among the multiple noise models by selecting, based on the flag signal, one of the first signal or the second signal and by calculating similarity in spectrum between the one of the first signal or the second signal selected and each of the multiple noise models; and
a spectral subtractor configured to perform spectral subtraction processing, based on the spectrum of the first signal and the one noise model selected by the noise model selector.

### 12

A noise processing method including:
detecting a sound source, based on multiple signals supplied from multiple microphones;
generating, based on a result of the detecting of the sound source, a flag signal that indicates a period during which the multiple signals each include a first signal component;
generating, based on the multiple signals and the flag signal, a first signal by emphasizing the first signal component in the period during which the multiple signals each include the first signal component;
generating, based on the multiple signals and the flag signal, a second signal by de-emphasizing the first signal component in the period during which the multiple signals each include the first signal component;
generating, based on the flag signal, multiple noise models in a period during which the multiple signals each do not include the first signal component, the multiple noise models each corresponding to a spectrum of the first signal;
selecting one noise model from among the multiple noise models, by selecting, based on the flag signal, one of the first signal or the second signal and by calculating similarity in spectrum between the one of the first signal or the second signal selected and each of the multiple noise models; and
performing spectral subtraction processing, based on the spectrum of the first signal and the one noise model selected from among the multiple noise models.

### 13

A non-transitory computer-readable recording medium including software, the software being configured to cause a processor to:
detect a sound source, based on multiple signals supplied from multiple microphones;
generate, based on a result of detecting of the sound source, a flag signal that indicates a period during which the multiple signals each include a first signal component;
generate, based on the multiple signals and the flag signal, a first signal by emphasizing the first signal component in the period during which the multiple signals each include the first signal component;
generate, based on the multiple signals and the flag signal, a second signal by de-emphasizing the first signal component in the period during which the multiple signals each include the first signal component;
generate, based on the flag signal, multiple noise models in a period during which the multiple signals each do not include the first signal component, the multiple noise models each corresponding to a spectrum of the first signal;
select one noise model from among the multiple noise models, by selecting, based on the flag signal, one of the first signal or the second signal and by calculating similarity in spectrum between the one of the first signal or the second signal selected and each of the multiple noise models; and
perform spectral subtraction processing, based on the spectrum of the first signal and the one noise model selected from among the multiple noise models.

The noise processing circuit, the signal processing device, the noise processing method, and the non-transitory recording medium according to at least one embodiment of the disclosure each make it possible to effectively reduce non-stationary noise.

1. A noise processing circuit comprising:
a detector configured to detect a sound source, based on multiple signals supplied from multiple microphones;
a flag signal generator configured to generate, based on a result of detecting by the detector, a flag signal that indicates a period during which the multiple signals each include a first signal component;
a beamforming processor configured to generate, based on the multiple signals and the flag signal, a first signal by emphasizing the first signal component in the period during which the multiple signals each include the first signal component, and a second signal by de-emphasizing the first signal component in the period during which the multiple signals each include the first signal component;
a noise model generator configured to generate, based on the flag signal, multiple noise models in a period during which the multiple signals each do not include the first signal component, the multiple noise models each corresponding to a spectrum of the first signal;
a noise model selector configured to select one noise model from among the multiple noise models by selecting, based on the flag signal, one of the first signal or the second signal and by calculating similarity in spectrum between the one of the first signal or the second signal selected and each of the multiple noise models; and
a spectral subtractor configured to perform spectral subtraction processing, based on the spectrum of the first signal and the one noise model selected by the noise model selector.

2. The noise processing circuit according to claim 1, wherein
the detector is configured to generate a sequence of metadata by detecting the sound source, the metadata indicating a kind of the sound source, and
the flag signal generator is configured to generate the flag signal, based on the sequence of the metadata.

3. The noise processing circuit according to claim 1, wherein the flag signal generator is configured to generate the flag signal, based on the result of the detecting by the detector and a user's sound source selection operation received by a user interface.

4. The noise processing circuit according to claim 1, wherein
the beamforming processor is configured to, based on the flag signal,
in the period during which the multiple signals each include the first signal component, adjust a first processing setting of the beamforming processor to generate the first signal in which the first signal component is emphasized, and
in the period during which the multiple signals each do not include the first signal component, retain the first processing setting and generate the first signal by using the first processing setting.

5. The noise processing circuit according to claim 1, wherein
the beamforming processor is configured to, based on the flag signal,
in the period during which the multiple signals each do not include the first signal component, adjust a second processing setting of the beamforming processor to de-emphasize a second signal component of the first signal and to generate the second signal including the second signal component, and
in the period during which the multiple signals each include the first signal component, retain the second processing setting and generate the second signal by using the second processing setting.

6. The noise processing circuit according to claim 1, wherein
the noise model generator in configured to generate a first noise model, based on the spectrum of the first signal in a first period, and
the multiple noise models include the first noise model.

7. The noise processing circuit according to claim 1, wherein
the noise model generator is configured to generate a second noise model, based on the spectrum of the first signal in a first period and the spectrum of the first signal in a second period, and
the multiple noise models include the second noise model.

8. The noise processing circuit according to claim 1, wherein
the noise model generator is configured to, when the spectrum of the first signal exhibits a change greater than or equal to a predetermined degree, generate a third noise model corresponding to the spectrum after the change, and
the multiple noise models include the third noise model.

9. The noise processing circuit according to claim 1, wherein
the noise model selector is configured to, based on the flag signal, in the period during which the multiple signals each do not include the first signal component, select the first signal, out of the first signal and the second signal, and select the one noise model from among the multiple noise models, based on the first signal.

10. The noise processing circuit according to claim 1, wherein
the noise model selector is configured to, based on the flag signal, in the period during which the multiple signals each include the first signal component, select the second signal, out of the first signal and the second signal, and select the one noise model from among the multiple noise models, based on the second signal.

11. A signal processing device comprising
a noise processing circuit configured to perform noise processing, based on multiple signals supplied from multiple microphones, and
a processing circuit configured to perform signal processing, based on a result of processing by the noise processing circuit, wherein
the noise processing circuit includes:
a detector configured to detect a sound source, based on the multiple signals supplied from the multiple microphones;
a flag signal generator configured to generate, based on a result of detecting by the detector, a flag signal that indicates a period during which the multiple signals each include a first signal component;
a beamforming processor configured to generate, based on the multiple signals and the flag signal, a first signal by emphasizing the first signal component in the period during which the multiple signals each include the first signal component, and a second signal by de-emphasizing the first signal component in the period during which the multiple signals each include the first signal component;
a noise model generator configured to generate, based on the flag signal, multiple noise models in a period during which the multiple signals each do not include the first signal component, the multiple noise models each corresponding to a spectrum of the first signal;
a noise model selector configured to select one noise model from among the multiple noise models by selecting, based on the flag signal, one of the first signal or the second signal and by calculating similarity in spectrum between the one of the first signal or the second signal selected and each of the multiple noise models; and
a spectral subtractor configured to perform spectral subtraction processing, based on the spectrum of the first signal and the one noise model selected by the noise model selector.

12. A noise processing method comprising:
detecting a sound source, based on multiple signals supplied from multiple microphones;
generating, based on a result of the detecting of the sound source, a flag signal that indicates a period during which the multiple signals each include a first signal component;
generating, based on the multiple signals and the flag signal, a first signal by emphasizing the first signal component in the period during which the multiple signals each include the first signal component;
generating, based on the multiple signals and the flag signal, a second signal by de-emphasizing the first signal component in the period during which the multiple signals each include the first signal component;
generating, based on the flag signal, multiple noise models in a period during which the multiple signals each do not include the first signal component, the multiple noise models each corresponding to a spectrum of the first signal;
selecting one noise model from among the multiple noise models, by selecting, based on the flag signal, one of the first signal or the second signal and by calculating similarity in spectrum between the one of the first signal or the second signal selected and each of the multiple noise models; and
performing spectral subtraction processing, based on the spectrum of the first signal and the one noise model selected from among the multiple noise models.

13. A non-transitory computer-readable recording medium including software, the software being configured to cause a processor to:
detect a sound source, based on multiple signals supplied from multiple microphones;
generate, based on a result of detecting of the sound source, a flag signal that indicates a period during which the multiple signals each include a first signal component;
generate, based on the multiple signals and the flag signal, a first signal by emphasizing the first signal component in the period during which the multiple signals each include the first signal component;
generate, based on the multiple signals and the flag signal, a second signal by de-emphasizing the first signal component in the period during which the multiple signals each include the first signal component;
generate, based on the flag signal, multiple noise models in a period during which the multiple signals each do not include the first signal component, the multiple noise models each corresponding to a spectrum of the first signal;
select one noise model from among the multiple noise models, by selecting, based on the flag signal, one of the first signal or the second signal and by calculating similarity in spectrum between the one of the first signal or the second signal selected and each of the multiple noise models; and
perform spectral subtraction processing, based on the spectrum of the first signal and the one noise model selected from among the multiple noise models.
